(19) United States
(12) Patent Application Publication
(10) Pub. No.: US 2003/0100321 A1
(43) Pub. Date: May 29, 2003

(54) Instantaneous polling utilizing a message service mobile phone network

(76) Inventors: Herman Rao, Taipei (TW); Eric Lin, Tainan (TW)

Correspondence Address: BAKER & MCKENZIE, 805 THIRD AVENUE, NEW YORK, NY, 10022, US

(21) Appl. No.: 10/137,033

(22) Filed: May 1, 2002

(30) Foreign Application Priority Data
May 3, 2001 (TW) 90110663

(51) Int. Cl. H04M 11/10; H04Q 7/20

(52) U.S. Cl. 455/466; 455/412

(57) ABSTRACT

A polling system for voting, auction bidding, opinion surveying, and the like, communicable with mobile communications devices for performing information collection responsive to input from the mobile communications devices, utilizing an existing short message service (SMS) and/or Internet wireless applications protocol (WAP), and information processing means for processing and analyzing the information collected. The information so collected is stored, organized, analyzed, transmitted to the mobile communication devices using SMS, or through the Internet using WAP, or to Internet-connected devices of any kind. The polling results can be transmitted and graphically displayed in a smooth integration with existing presentation tools such as PowerPoint™ thereby achieving instantaneous polling results for pollsters, feedback to respondents, and visual display for mass media presentations.

### FIELD OF THE INVENTION

This invention relates generally to information collection and analysis and more specifically to information polling utilizing mobile communication devices communicable with data analysis and presentation systems.

### BACKGROUND OF THE INVENTION

Of particular present day interest is the implementation of new features and capabilities of mobile communication devices such as mobile phones. Short Message Services (SMS) on mobile phone systems allow the transmission of written messages between cellular phones which can be received regardless of whether the phones are connected or in use, thereby providing a very handy message communication capability. Many present day digital cellular phone systems provide this service, among them, Global System for Mobile Communications (GSM), Digital Advanced Mobile Phone Service (DAMPS based on Time-Division Multiple Access, IS-136/TDMA), and CdmaOne (based on Code Division Multiple Access, IS-95/CDMA). As an example of SMS implementation, the GSM SMS is a low-capacity, low-time performance service which can contain up to 140 octets or 160 characters of GSM default alphabet. The GSM SMS operates like a paging service with the added capability of bi-directional transmission. Short messages are transmitted on the GSM Stand-alone Dedicated Control Channel so that messages can be sent to and received by mobile phones that are in conversation at the time. Cell Broadcast service periodically delivers short messages to all subscribers in a given geographical area and Point-to-Point service provides messages to a specific user.

FIG. 1 schematically illustrates the GSM SMS network architecture. A mobile phone 101 (or “mobile station”, “MS” as used in the industry) transmits a short message to base transceiver station 102, which transmits the short message to base station controller 103, which in turn transmits the short message to mobile switching center (MSC) 104 which is a short message service interworking mobile switching center (SMS IWMSC) 105. IWMSC 105 transmits the short message to short message service center (SM-SC) 106. Upon receipt of the short message, SM-SC 106 may send an acknowledgment signal back to the originating MS if an acknowledgment request is specified in the short message. SM-SC 106 then forwards the short message to the destination GSM network through a specific GSM MSC called the short message service gateway MSC (SMS GMSC) 107. Utilizing the GSM roaming protocol, SMS GMSC 107 locates the serving MSC 108 of the message receiver and forwards the short message thereto. MSC 108 pages the short message to base station controller (BSC) 109 which when paged successfully then transmits the short message to the base transceiver stations (BTSs) 110 which transmits to the transmitting antennae 111, 112, 113, . . . to locate the terminating (or destination) MS 114. Every short message contains a header in addition to the body of the message. The header includes the originating MS address, the terminating MS address, the serving SM-SC address, a time stamp, and the length of the message body. Mobile Station ISDN (Integrated Services Digital Network) Numbers (MSISDN) or GSM telephone numbers are used for addressing. Presently, every standard mobile phone has decoding and storing software to support the short message service. The mobile phone typically is functionally separated into the Mobile Equipment (ME) part and a Subscriber Identity Module (SIM) card which typically includes a subscriber-selected Personal Identity Number (PIN), dialing numbers, names of preferred networks to provide service, and the like. Some of the SIM information can be modified by using the keypad of the mobile phone or through a connected personal computer. The ME typically includes non-subscriber-related hardware and software specific to the radio interface. When the SIM is removed from the ME, the ME can no longer be used for reaching the service provider except for emergency calls. Received short messages can be stored in either the SIM or the ME, and are displayed on the mobile phone LED screen. There are typically three types of short messages: User-specific messages, ME-specific messages, and SIM-specific messages. A user-specific message is displayed on the user's mobile phone display. A ME-specific message is processed within the mobile equipment and is not displayed to the user. Special functions created by the mobile phone vendor can also be triggered by the ME-specific message. For example, the Nokia Smart Message™ includes playing a ringing tune, displaying a business card, default icon modification capability, and so on. A SIM-specific message is processed in the SIM card and any special function designed-in can be triggered by the SIM-specific message. If the mobile phone is not turned on, or otherwise not connected to the mobile phone network, the short message service center will repeatedly re-send the message until receipt (or the expiration of the message). There is no limitation on how many undelivered messages per mobile phone can be cached at the short message service center.

Mobile Internet access through mobile phones, PDAs, and other hand-held electronic devices is currently being implemented in many countries utilizing the Wireless Application Protocol (WAP). The Wireless Markup Language (WML), defined by WAP, is a modified subset of the Web markup language Hypertext Markup Language (HTML), scaled appropriately to meet the physical constraints and data capabilities of present day mobile devices (for example the Global System for Mobile (GSM) phones). Proposals for data rate improvements include General Packet Radio Service (GPRS), Enhanced Data Rates for GSM Evolution (EDGE), and the Third Generation Universal Mobile Telecommunications System (3G-UMTS)

### SUMMARY OF THE INVENTION

There is a need for new functions that can be quickly implemented on existing platforms without significant new or revised hardware and software systems. The functions must be scalable both as to users and features and would ideally require little or no maintenance from existing phone network operators, thereby overcoming implementation barriers. The present invention is a polling system for voting, auction bidding, opinion surveying, and the like, communicable with mobile communications devices for performing information collection responsive to input from the mobile communications devices, utilizing an existing short message service (SMS) and/or Internet wireless applications protocol (WAP), and information processing means for processing and analyzing the information collected. The information so collected is stored, organized, analyzed, transmitted to the mobile communication devices using SMS, or through the Internet using WAP, or to Internet-connected devices of any kind. The polling results can be transmitted and graphically displayed in a smooth and convenient integration with existing presentation tools such as PowerPoint™ thereby achieving instantaneous polling results for pollsters, feedback to respondents, and visual display for mass media presentations.

### BRIEF DESCRIPTION OF THE DRAWINGS

FIG. 1 is a block diagram of a prior art mobile phone short message service system.

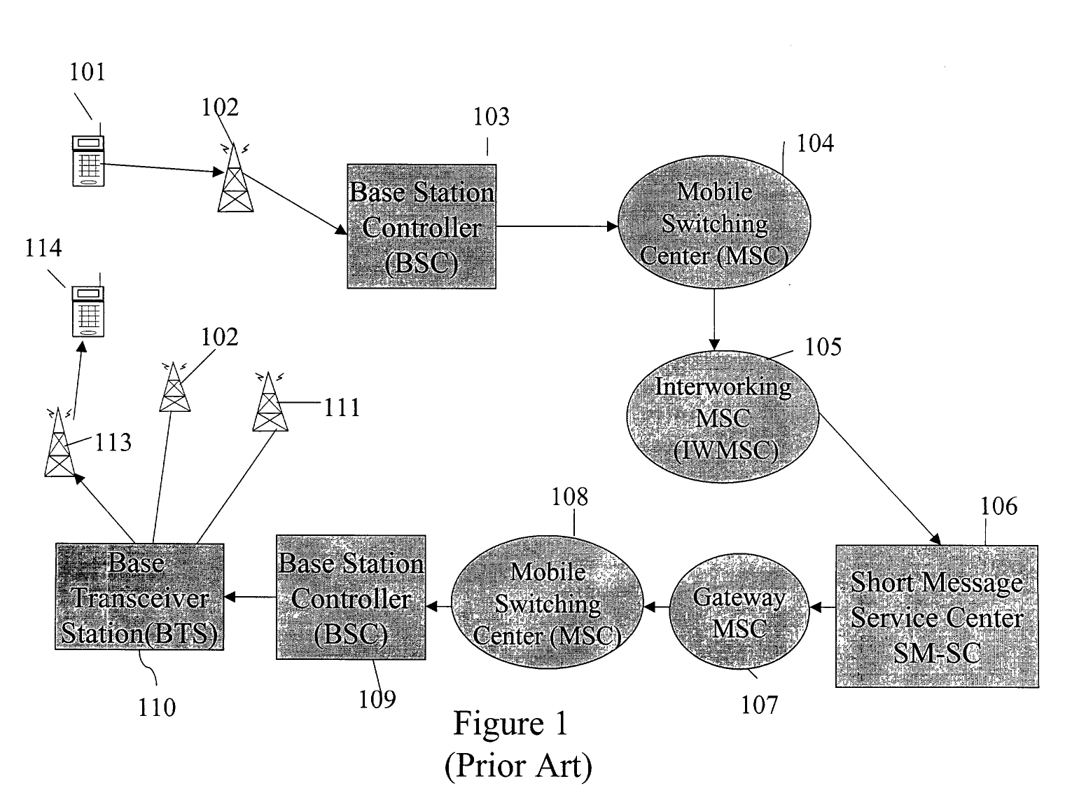

FIG. 2 is a schematic illustration of the instantaneous polling system utilizing a telecommunications network utilizing short message services according to the present invention.

FIG. 3 is a schematic illustration of a system with Internet access by mobile communication devices through existing short message services of telecommunication companies.

FIG. 4 is a block diagram of a gateway device having an iSMS server and a short message driver.

FIG. 5 is a schematic illustration of the preferred embodiment of an iSMS system having a iSMS server structure including a polling agent, a results agent, and polling data processors.

### DETAILED DESCRIPTION OF THE INVENTION

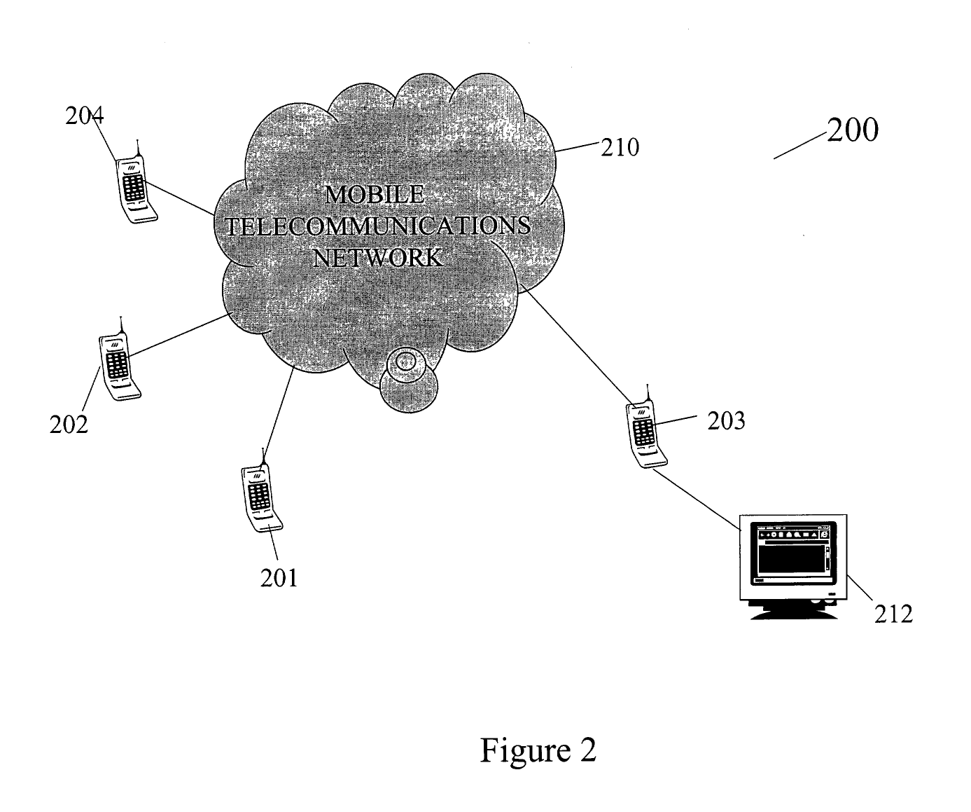

FIG. 2 is a schematic illustration of the instantaneous polling system 200 according to the present invention. Mobile communication devices 201, 202, 203, and 204 communicate through the mobile telecommunictions network 210. One of the mobile communication devices 203 is coupled to a computer 212 which performs the storage and processing of the polling information collected from the various mobile communication devices 201, etc. through the short message service (SMS) of the mobile telecommunications network 210. In various embodiments of the present invention, mobile communication devices 201, etc. can be cellular phones, satellite phones, local area network phones, personal digital assistants (PDAs), or specialized communication devices of any sort which are communicable with mobile telecommunications network 210. In one embodiment of the present invention, computer 212 is a personal computer. In another embodiment, computer 212 is a notebook computer thereby achieving mobility of the storage and processing function. Mobility management of a notebook computer coupled to MS modem 203 is automatically achieved by mobile device network 310 tracking systems since MS modem 203 is a mobile device. For example, GSM MAP (Mobile Application Part) currently provides such tracking. In another embodiment, computer 212 is a server or other type more powerful computer, thereby achieving greater data collection and information analysis power. Because it is designed for quick and short messaging, short message service utilization by the present invention provides almost instantaneous polling results.

The polling performed by instantaneous polling system 200 is limited only by the imagination of users. Information can be polled from anyone with access to a telecommunications network. That information can be voting ballots, auction bids, opinion surveys, and many other types of information. The information once collected can be processed and analyzed to produce voter profiles, demographic analyses, specific group preferences (where, for example, the respondents are members of a predetermined group of subscribers), comparison and ranking of auction bid prices and the like. In addition, the results of the polling (or auctions) can be instantaneously displayed, using for example Microsoft's Power Point™, Access™, or Excel™, by utilizing an object embedding feature (such as Microsoft's Object Linking and Embedding (OLE)) wherein the connection between source (e.g., polling data collection file in computer 212) and target (e.g. Power Point™ file in computer 212) is maintained so that any changes in the source data are automatically and instantaneously shown in the target. In this way, the present invention achieves instantaneous polling results presentation capability. That is, the polling question is posed in one slide of the presentation, and the mobile communication device users vote with the results being object linked and embedded in the presentation's next slide, thereby achieving instantaneous results presentation. The present invention provides a smooth and convenient integration with existing presentation tools and of course any such presentation system utilized in conjunction with the present invention is within the contemplation of this invention.

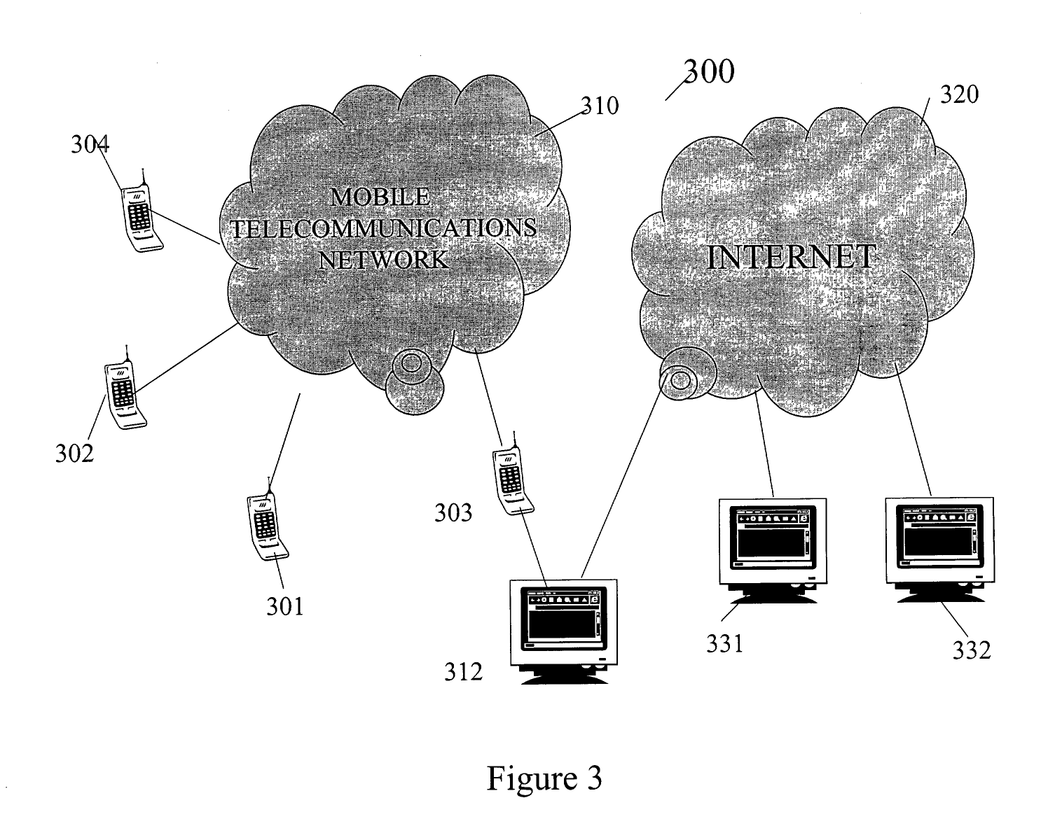

FIG. 3 schematically illustrates a system iSMS 300 for Internet access by mobile communication devices through existing short message services (SMS) of telecommunication companies (the subject of another patent application of the Assignee of the present invention). The polling function of the present invention is implemented on iSMS system 300 which comprises mobile devices 301, 302, 303, . . . , (termed in the art “MS” for “mobile station”) communicating with one another through a mobile device network 310 (for example, mobile phones on the GSM network). One of the mobile devices, MS modem 303 is coupled to gateway device 312 which communicates with a communications network 320, for example the Internet. Personal computers 331 and 332 also communicate with the Internet 320. In one embodiment, gateway device 312 is a personal computer utilizing one of the Windows 95, Windows 98, NT, or UNIX operating systems. In another embodiment, gateway device 312 is a notebook computer, thereby making gateway device 312 mobile. It is understood that any computer with the requisite computational capability, and any modern operating system can be advantageously utilized in the present invention. In various configurations, the Nokia Card Phone, Nokia 6150, Ericsson GC25, and Ericsson SH888 are utilized as MS modem 303. In different embodiments of the present invention, MS modem 303 and gateway device 312 are coupled by a RS232 port, or an infrared port (such as IrDA), or a wireless connection device using radiofrequency transmission bands such as Bluetooth, or a PCMCIA interface. Information signals transmitted from the Internet 320 to mobile device network 310 are automatically packaged into short messages. Also, if one or more servers (not shown) are coupled to gateway device 312, mobile devices 301, etc. can broadcast short messages to the servers connected to gateway device 312. iSMS system 300 is identified by the Internet 320 through an IP address assigned to gateway device 312, and is addressed through mobile device network 310 by means of a digital network (such as the MSISDN). Thus, the mobile device network phone number of MS modem 312 is its communication address.

In one embodiment of the present invention, the polling is achieved utilizing the short message service (SMS) of mobile telecommunications network 210 and the polling results are distributed through the Internet to mobile communication devices 301 etc. utilizing wireless application protocol (WAP). WAP has the advantage of broader bandwidth (more content transmittable) and SMS the advantage of speed (dial-up time on WAP typically requires 20 seconds whereas SMS is almost instantaneous). WAP currently is a “pull” protocol where the Internet “pulls” in users, whereas SMS is a push/pull protocol since it is a telephonic function wherein a caller can call many other users (“push”) for responses. Therefore, currently, SMS is superior to WAP for the polling function, but this invention contemplates the utilization of both SMS and WAP for the polling function.

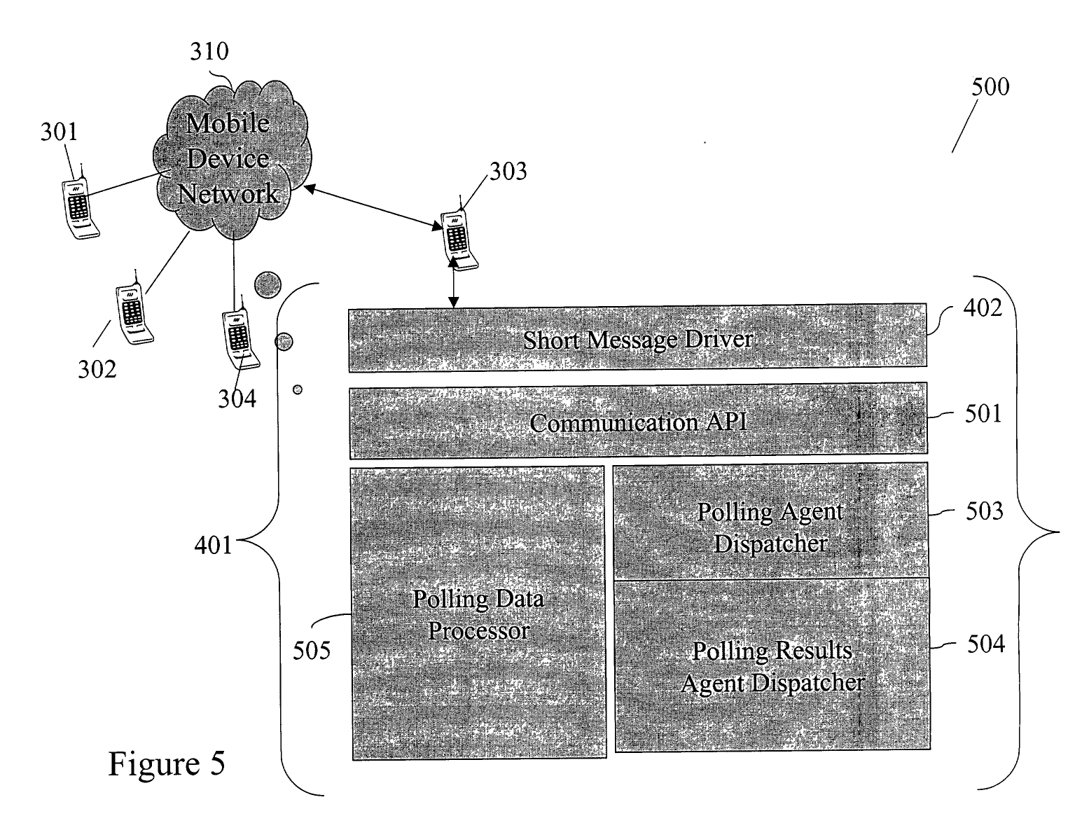

FIG. 3 can also schematically illustrate another embodiment of the present invention wherein Internet wireless application protocol (WAP) is utilized as the communication means for the polling function contemplated in the present invention. Mobile communication devices 301, 302, 304, etc. communicate with a network communications system such as the Internet 320 via mobile communication device 203 as the MS modem coupling a WML gateway computer 312 which can also serve as polling agent dispatcher, polling results processor, and polling results transmitter (in analogy with server 401 of FIG. 5 below minus the SMS driver). Because of the wider bandwidth and content capability of WAP compared to SMS, a greater variety of, and more in-depth, polling information can be processed in this embodiment for communication with mobile communication devices 301, etc. In one embodiment of the present invention, computer 331 is the mobile device website for mobile communications devices 301, etc. and computer 332 and others, in communication with the Internet, can also receive polling results and display computationally intensive and extensive graphical representations of the results.

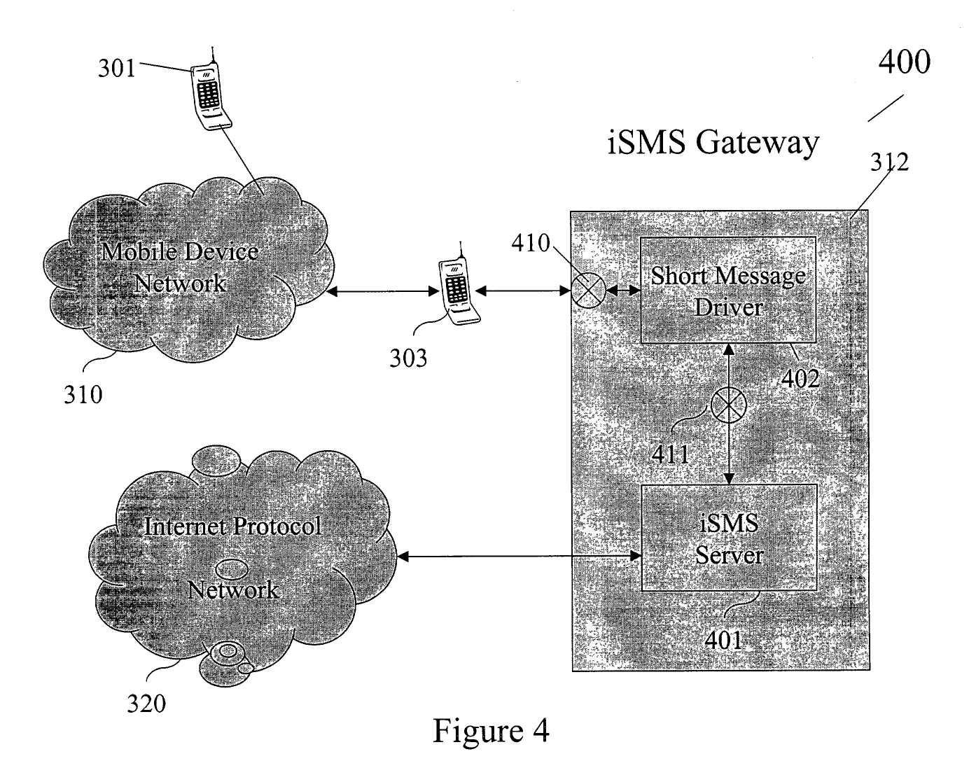

FIG. 4 is a block diagram of a gateway device 312 comprising an iSMS server 401 for service provisioning and a short message driver 402 for the communication interface between mobile device network 310 and iSMS server 401. In one embodiment of the present invention, the communication protocol between MS modem 303 and short message driver 402 utilizes an SMS AT command set (rf. GSM Technical Specification GSM 07.05 Version 5.3.0, ETSI, August 1997). The communication system between iSMS server 401 and the short message driver 402 utilizes an iSMS communication application programming interface (API) based on a TCP socket. In one embodiment, short message driver 402 is coupled to MS modem 303 by a RS232 port utilizing serial port number 4. In a test embodiment of the present invention, short message driver 402 utilizes two serial ports: the NULL port accepts outgoing short messages, the LOOPBACK port sends back outgoing messages as incoming short messages, and the MOBILE_COM_PORT identifies which port is connected. The SMS AT Command Set communication protocol requires specification of the specific MS modem 303 for a given mobile device. MS modem 303 setup is achieved by utilizing two variables MOBILE_TYPE and MOBILE_INIT_STRING. Some of the AT commands utilized in the preferred embodiment of the present invention are shown in Table I.

TABLE I
AT Commands Used in iSMS (partial list)

| AT COMMAND | DESCRIPTION |
|---|---|
| +CNMI | New Message Indications to TE |
| +CSCA | Service Center Address |
| +CMGD | Delete Message |
| +CMGL | List Message |
| +CSMP | Set Text Mode Parameters |
| +CMT | SMS Message Received |

Every command sent from short message driver 402 begins with “AT” (for example, “AT+CMGS”). The response from MS modem 303 deletes the “AT” portion (for example, “+CMGS”). Upon receipt of a message from iSMS server 401, short message driver 402 divides the message into several segments of length less than 140 octets. For each receiver, short message driver 402 generates a set of SMS packets from the message segments. For example, if the message is divided into four segments and there are three receivers, then short message driver 402 generates 12 SMS packets, pushes them into a FIFO queue, and transmits them sequentially. For every SMS packet, short message driver 402 issues the appropriate SMS AT command instructing exemplary mobile device 301 to submit a short message. Mobile device 301 utilizes two command modes: text mode and packet data unit (PDU) mode which entail different AT command parameters; however, most present mobile devices support the PDU command mode wherein the parameter for sending short messages is the entire short message packet. For example, the “Send Message” AT command is “+CMGS” which has the packet mode format:

AT+CMGS=<length><CR><pdu>

where <length> is the length of the actual data unit in octets. The <pdu> delivering the short message is called SMS-SUBMIT in the format:

| 0 1 | 2 | 3 4 | 5 | 6 | 7 | length | |
|---|---|---|---|---|---|---|---|
| MTI | RD | VPF | SRR | UDHI | RP | 1 | octet |

| | | |
|---|---|---|
| Message Reference | 1 | octet |
| Length of Destination Address | 1 | octet |
| Type of Destination Address | 1 | octet |
| Destination Address | 10 | octets |
| . . . | | |
| Protocol Identifier | 1 | octet |
| Data Coding Scheme | 1 | octet |
| Validity Period | 1, 7 | octets |
| . . . | | |
| User Data Length | 1 | octet |
| User Data | 140 | octets |
| . . . | | |

where MTI (Message Type Indicator) is 01 for SMS-SUBMIT, RD (Reject Duplicates) indicates whether the short message service center (SM-SC) should reject the duplicated SMS-SUBMIT packet, VPF (Validity Period Format) specifies the format of the Validity Period field (the validity period being the time interval that the short message can be buffered in the short message service center in the event that the message cannot be delivered immediately to the recipient, SRR (Status Report Request) indicates whether a status report should be sent back to the sender, UDHI (User Data Header Indicator) is just that, and RP (Reply Path) indicates whether the reply path is used or not. Upon transmitting an SMS packet containing a message to mobile device 301, short message driver 402 issues the following AT Command to MS modem 303:

AT+CMGS=34<CR>

11000C918896632143650000A716C8340B847EDF34617919947FD734F437399CFF01<EOF>

where <CD> is the hex code OD and <EOF> is the hex code 1A. The first parameter is the number of octets in this packet (34) and the second parameter is the SMS-SUBMIT packet. Upon successful transmission of the packet, MS modem 303 replies to short message driver 402 with the Message Reference number as follows:

+CMGS:150<CR><LF><CR><LF>OK<CR><LF>.

Upon receipt of a short message, MS modem 303 notifies short message driver 402 using the +CMT command with PDU mode format:

+CMT:,<length><CR><pdu>

where the first parameter is null, the second parameter <length> is the number of octets in the packet, and the third parameter <pdu> is the SMS-DELIVER packet. The SMS-DELIVER format is similar to that of SMS-SUBMIT except that SMS-DELIVER includes fields such as MMS (More Messages to Send) indicating whether there are more messages to be sent to MS modem 303 and SRI (Status Report Indicator) indicating whether MS modem 303 should return a status report to the short message service center. An example of this command is:

+CMT:,28<CR><LF>

040C9188966321436500009901229095848A0A4950B0D32A7DD6517<CR><LF>

where the parameter <length> is 28 and <pdu> contains the sender's phone number and the message text. In the preferred embodiment of the present invention, the iSMS system 400 API utilizes the Visual C++ programming language so that servers and agents can be conveniently developed; however, it is understood by those in the art that any programming language can be advantageously utilized for this purpose and any and all such languages are within the contemplation of the present invention. For every application, an iSMS server 401 (exemplary) communicates with short message driver 402 through TCP port 341 and a plurality of agents may be created to interact with iSMS server 401 through command execution.

In one embodiment of the present invention, the API for iSMS system 400 is a class CsmsdServer which implements the following communications functions between exemplary iSMS server 401 and exemplary short message driver 402: The Connect () function establishes a communication link from iSMS server 401 to short message driver 402 having two arguments, the IP address of exemplary short message driver 402 and the port number for TCP port number of short message driver 402 with a return connection establishment status signal. Disconnect () terminates the TCP link between iSMS server 401 and short message driver 402. SetTimeout () sets a timeout period when iSMS server 401 issues an operation to short message driver 402; if the TCP port 341 socket is not ready before the specified time expires, the operation fails. Register () specifies the customers of exemplary iSMS server 401 utilizing, for example, their individual phone numbers. The argument in this embodiment includes an array of phone numbers and the size of the array. Status () returns the communication status between iSMS server 401 and short message driver 402 as follows: SMCMD_READABLE indicates that iSMS server ready for retrieval of short message from short message driver 402; SMCMD_WRITABLE indicates that iSMS server 401 is ready for sending a message to short message driver 402; SMCMD_ACK indicates that the message from iSMS server 401 to short message driver 402 was successfully received by the latter; and SMCMD_CLOSED indicates the closure of the connection. Send () sends data to one or more customers (for example, GSM subscriber mobile phones). The input argument includes: receiver, an array of strings containing the identification numbers (for example telephone numbers); number, array size; data, the buffer storing binary data to be transmitted; length, the length of the data (limited in present short messages to 65535 octets), dcs, the data coding scheme (DCS) for transmission (the alphabet of the message (for example, 7-bit GSM, 8-bit Data, or 16-bit Unicode) and the class of the SMS (for example ME-specific or SIM-specific); option, the SMS transmission option (in one embodiment of the present invention, the UDHI option); and UDHI flag, the SMS data contains some user-defined header (defined in GSM 03.40 and used, for example, in Nokia's smart messages). The output argument item is ret_num which is the reference number of the message transmitted. RecvACK () returns acknowledgment from short message driver 402 for the status of the message transmission. The output argument includes ref_num, the reference number of the message being acknowledged; receiver_index the first customer in the receiver list that iSMS server 401 fails to deliver the message to; data_index, the first octet in the data buffer, after which the transmission failed (when data_index is −1, the message was delivered successfully to all intended recipients). Recv () is invoked by iSMS server 401 for receiving data from exemplary mobile device 401 (for example, a GSM handset) and includes in its argument sender, specifying the sender phone number; data specifying a buffer for storing the delivered short message, length, the length of the message, dcs, the data coding scheme, and option, the transmission option. In a preferred embodiment of the present invention, CsmsdServer provides another two send functions for facilitating text messages and unstructured binary data. SendText () is used to send a message with a null-terminated string of ISO-8859-1 characters or Chinese (BIG 5) characters. SendData () is used to send unstructured binary data using GSM 8-bit coding without setting the UDHI flag of the SMS packet. An example of the polling function command set is a start/end (VS, VE commands respectively), and for single answer questions, one SMS relay for the single answer to a single question and another SMS relay for individual anwers to specific questions. For multiple answers for a single question, there is another SMS relay. Each type of polling function has a specific command set within the general form described in detail above.

In operation, initialization of iSMS system 400 begins by short message driver 402 opening COM port 340 for transmitting/receiving short messages to/from mobile device network 340 via MS modem 403. Short message driver 402 also opens and listens on pre-defined TCP port 341 for server connection requests. For each connection request, iSMS server 402 registers the identification number (for example, the telephone number in a mobile phone system) of the user's mobile device 401 to short message driver 402. Messages from registered senders are then forwarded to iSMS server 401. Short message driver 402 performs the conversion for signals between the iSMS server 401 interface (for example, TCP port 341's API) and the MS modem 403 interface (for example, the SMS AT Command Set). Short message driver 402 receives incoming short messages from COM port 340 and passes the messages to iSMS server 401 according to a registration table. Depending on the registration status, short message driver 402 may forward a message to several different iSMS servers (such as 401) which have registered the message sender or drop the message if they have not registered the sender. For outgoing short messages, short message driver 402 receives messages from other iSMS servers (like 401), converts the messages into short message format, and transmits them to mobile device networks via COM port 340.

In one embodiment of the present invention, iSMS server 401 runs on the same host as short message driver 402. In another embodiment, iSMS server 401 runs on a different host at a remote site. In the preferred mode, for security, short message driver 402 authenticates iSMS server 401 before initiating a communication session. For each incoming message from short message driver 402, iSMS server parses the message body and then invokes appropriate internal functions or external agents to execute the messages. Functions run in the same address space as iSMS server 401 and agents run on different processes.

New services are instituted on iSMS system 400 by programming iSMS server 401 which communicates with short message driver 402 through utilization of the functions defined in an iSMS communication API. The iSMS system 400 platform thus provides flexibility to implement a plurality of new server types. FIG. 5 illustrates the preferred embodiment of an iSMS system 500 wherein the iSMS server 401 structure includes a polling agent dispatcher 503, a polling results agent dispatcher 504, and polling data processor 505. In the preferred embodiment of the present invention, polling agent dispatcher 503 performs the polling query distribution function and polling data processing server 505 stores, processes, and analyzes the polling data collected. In an embodiment of the present invention, polling data processor 505 organizes the polling data in graphical form utilizing, for example, Microsoft's PowerPoint™, Excel™, or Access™, and an object embedding feature (such as Microsoft's OLE) so that any changes in the polling data collection are automatically and instantaneously shown in the graphical results presentation file. Thus the present invention can pose the polling question in one slide of the presentation, and after the mobile communication device users vote, the results are shown in the presentation's next slide, thereby providing almost instaneous graphical results and/or feedback. Thus the present invention provides a convenient and smooth integration with existing presentation tools of any kind. It is understood that any data analysis program and presentation system can be advantageously utilized in the present invention to analyze and present the polling data. Server 505 is coupled to a communications API 501, which in turn is coupled to short message driver 402 which is coupled to mobile device network 310 through MS modem 303. The polling result information is thus transmittable almost instantaneously to mobile communication devices 301, 302, 304, etc. so that subscribers will know the results of the poll almost immediately. Relatively low content information is transmitted through the short message service of the telecommunications network. In another embodiment, higher content information is transmitted utilizing wireless application protocol (WAP) through the Internet to mobile communication devices 301, 302, etc. In another embodiment of the present invention, iSMS server 401 being coupled to the Internet 320 (FIG. 4), transmits polling result information in any form, including graphical form, through the Internet to individual Internet-connected computers which can thus display higher content, more complex graphical information.

In general operation, agent dispatcher 503 invokes an agent responsive to the SMS message header and passes the message body as the parameters to the agent. In the preferred embodiment, each agent implements one function and upon completion of the processing of the message, agent dispatcher 403 collects the results and sends them back to short message driver 402. Agent dispatcher 504 implements its own message parsing rules and maintains a command table with function/agent pairs. The preferred embodiment of iSMS system 500 comprises a general-purpose agent dispatcher platform whose details of communication between short message driver 402 and agent dispatcher 503 are opaque to service developers. In this embodiment, polling service developers need only specify the agent dispatching rules and implement the agents to carry out the polling services.

User-defined server 505 only requires a developer to implement the interaction between short message driver 402 and user-defined server 505. A communication API provides convenient development of different servers for different services. For polling functions where demographic analysis is desired, iSMS server 401 can also maintain user profiles where appropriate and can actively collect information from different Internet servers and maintain personal profile repositories for individual subscribers. Profiles are organized on a per-user basis (according to phone number) utilizing the format keyword=value where value could be for phone number, address, personal note, and the like. Subscribers utilizing mobile device 301, 302, 303, . . . , can add an entry to their personal profile by sending a short message to iSMS server 401, for example, PB Robin+19179075010, which instructs iSMS server 401 to add a new entry to the profile. The user may query the entry utilizing a keyboard by sending the message PQ Robin. iSMS server 401 responds by returning the message Robin=+19179075010. Group message forwarding to all members of a designated group can also be conveniently implemented through designation of unique names and telephone numbers. Thus a segmented (or demographic) polling can be performed using responses only from members of the designated group. A short message requesting votes sent to a group is forwarded to all members of the group. The present invention provides creation of the group with founding members, querying members, adding/deleting members, and sending messages to a designated group so that polling can be demographically or otherwise segmented. Further, multi-player games of all kinds can be implemented under this group communication structure.

Smart message delivery (such as Nokia's Smart Message™) utilizeASCII format streams so smart messages can be passed via different transport protocols. Smart messaging has been adopted by major GSM mobile phone suppliers for short messaging services and in messaging for personal digital assistant (PDA) devices, and wireless connection devices using radiofrequency transmission bands such as Bluetooth. The polling function of the present invention advantageously utilizes such smart message delivery for enhancement of the polling queries and responses.

While the above is a full description of the specific embodiments, various modifications, alternative constructions and equivalents may be used. For example, the present invention also contemplates personal digital assistant (PDA) devices for transmitting/receiving short messages to/from the Internet or other communications networks. Therefore, the above description and illustrations should not be taken as limiting the scope of the present invention which is defined by the appended claims.

What is claimed is:

1. In a telecommunications system including a plurality of mobile communication devices and having a message service capability, a polling information system comprising:
information collection means, communicable with at least one of the mobile communications devices, for performing information collection responsive to input from the mobile communications devices utilizing the message service;
information storage means for storing the information collected; and
information processing means for processing the information collected.

2. The polling information system of claim 1 wherein said information collection means, said information storage means, and said information processing means are disposed in a computer.

3. The polling information system of claim 2 wherein said computer is a mobile computer.

4. The polling information system of claim 1 wherein said information collection means communicates group messages to predetermined members of a group subscribing to the mobile communications devices message service.

5. The polling information system of claim 1 wherein said information collection means communicates Nokia format smart messages between the mobile communications devices and said information collection means.

6. The polling information system of claim 1 wherein said information processing means collects polling data.

7. The polling information system of claim 1 wherein said information processing means displays the information collected by said information collection means on a display device.

8. The polling information system of claim 7 further comprising a means for object linking and embedding said information storage means to said information processing means to automatically and instantaneously display the information on said display device.

9. The polling information system of claim 1 wherein said information storage means stores information regarding sender identification, message content, and time message sent.

10. The polling information system of claim 1 wherein said information processing means continually updates the information collected by said information collection means and stores the updated information in said information storage means.

11. The polling information system of claim 1 wherein said information processing means performs statistical calculations and analysis on the information collected by said information collection means.

12. The polling information system of claim 1 further comprising a display device for displaying the information collected by said information collection means, processed by said information processing means, and stored by said information storage means.

13. The polling information system of claim 1 further comprising a polling result transmission agent for transmitting the results of the statistical calculations and analysis to the mobile communication devices.

14. In a telecommunications system including a plurality of mobile phones, a polling information system comprising:
information collection means, communicable with at least one of the mobile phones, for performing information collection responsive to input from the mobile phones;
information storage means for storing the information collected; and
information processing means for processing the information collected.

15. The polling information system of claim 14 wherein said information collection means, said information storage means, and said information processing means is a mobile computer.

16. In a telecommunications system including a plurality of mobile communication devices and having a short message service capability, and a network communications system, a polling information system comprising:
a gateway device, communicable with at least one of the mobile communications devices and a network communications system, for linking the plurality of mobile phones to the network communications system utilizing the short message service;
a first agent for performing information collection utilizing the short message service responsive to input from the mobile communications devices;
a processor for processing the information collected;
a storage device for storing the information collected and processed; and
a second agent for transmitting the processed information to a plurality of predetermined subscribers.

17. The polling information system of claim 16 wherein said gateway device is a personal computer.

18. The polling information system of claim 16 wherein said gateway device is a mobile computer.

19. The polling information system of claim 16 wherein said information collection agent communicates group messages to predetermined members of a group subscribing to the mobile communications devices message service.

20. The polling information system of claim 16 wherein said first agent collects voting data.

21. The polling information system of claim 16 further comprising a display device for displaying the information collected by said information collection means, processed by information processing means, and stored by said information storage means.

22. The polling information system of claim 21 further comprising a means for object linking and embedding said information storage means to said information processing means to automatically and instantaneously display the information on said display device.

23. The polling information system of claim 21 wherein said information storage means stores information regarding sender identification, message content, and time message sent.

24. The polling information system of claim 16 wherein said information processing means continually updates the information collected by said information collection means.

25. The polling information system of claim 16 wherein said information processing means performs statistical calculations and analysis on the information collected by said information collection means.

26. The polling information system of claim 16 wherein said gateway device communicates Nokia format smart messages between the mobile communications devices and the network communications system.

27. The polling information system of claim 16 wherein the network communications system is the Internet.

28. The polling information system of claim 16 wherein the telecommunications system is the GSM.

29. The polling information system of claim 16 wherein the mobile communications devices in the telecommunications system are personal digital assistants.

30. The polling information system of claim 16 wherein said second agent for transmitting the processed information transmits the processed information to the plurality of mobile communication devices utilizing the short message service.

31. The polling information system of claim 16 wherein said second agent for transmitting the processed information transmits the processed information to the plurality of mobile communication devices via the network communications system utilizing wireless application protocol (WAP).

32. The polling information system of claim 16 wherein said second agent for transmitting the processed information transmits the processed information via the network communications system to predetermined subscribers of the network communications system.

33. In a telecommunications system including a plurality of mobile communication devices, and the Internet having a wireless application protocol, a polling information system comprising:
a first agent for performing information collection via the Internet utilizing the wireless application protocol responsive to input from the mobile communications devices; and
a processor for processing the information collected;
a storage means for storing the informaion collected and processed; and
a second agent for transmitting the processed information to a plurality of predetermined Internet and telecommunicatins system subscribers.

34. In a telecommunications system including a plurality of mobile communication devices and having a short message service, a method for polling information and transmitting poll results, comprising the steps of:
collecting the information responsive to short messages sent through the mobile communications devices;
processing the information collected; and
transmitting the processed information back to the mobile communication devices.

35. The polling method of claim 34 wherein said information collected comprises voting information.

36. The polling method of claim 34 wherein said information collected comprises auction bidding information.

37. The polling method of claim 34 wherein said information collecting step comprises collecting information regarding message sender identification, message content, and time message sent.

38. The polling method of claim 34 wherein said information collecting step comprises the step of collecting information from predetermined groups of subscribers.

39. The polling method of claim 34 wherein said processing step comprises the step of storing the information collected.

40. The polling method of claim 34 wherein said processing step comprises the step of displaying the information collected.

41. The polling method of claim 40 wherein said displaying step comprises object linking and embedding the information to automatically and instantaneously display the processed information.

42. The polling method of claim 34 wherein said processing step comprises the step of continually updating the information collected.

43. The polling method of claim 34 wherein said processing step comprises the step of performing statistical calculations and analysis on the information collected.

44. The polling method of claim 34 wherein said processing step comprises the step of displaying the results of the statistical calculations and analysis on a display device.

45. The polling method of claim 34 wherein said information collecting step comprises the step of collecting information from personal databases.

46. The polling method of claim 34 wherein said information collecting step comprises the step of collecting opinion survery information.

47. The polling method of claim 34 wherein said transmitting results step utilizes the short message service.

48. In a telecommunications system including a plurality of mobile communication devices and having a short message service, and a network communications system, a method for polling information, comprising the steps of:
collecting the information responsive to short messages sent through the mobile communications devices;
processing the information collected; and
transmitting the processed information to predetermined users.

49. The polling method of claim 48 wherein said transmitting results step transmits the processed information through the network communication system.

50. The polling method of claim 48 wherein said transmitting results step utilizes wireless application protocol (WAP) to transmit the processed information to the mobile communication devices via the network communications system.

51. The polling method of claim 48 wherein said transmitting results step transmits the processed information to predetermined subscribers of the network communications system via the network communications system.

52. In a telecommunications system including a plurality of mobile communication devices and the Internet having a wireless application protocol for communication with the mobile communication devices, a method for polling information, comprising the steps of:
collecting the polling information responsive to messages sent via the wireless application protocol from the mobile communications devices;
processing the information collected; and
transmitting the processed information to predetermined subscribers of the Internet and the telecommunications system.
